(19) United States
(12) Patent Application Publication
(10) Pub. No.: US 2018/0333687 A1
(43) Pub. Date: Nov. 22, 2018

(54) APPARATUS FOR GENERATING FINE-BUBBLE-CONTAINING LIQUID

(71) Applicant: NORITAKE CO., LIMITED, Nagoya-shi, Aichi (JP)

(72) Inventors: Tomokazu EDA, Nagoya-shi (JP); Keita MIYAJIMA, Nagoya-shi (JP); Teruhisa FUJII, Nagoya-shi (JP); Yusuke SHIMIZU, Nagoya-shi (JP)

(73) Assignee: NORITAKE CO., LIMITED, Nagoya-shi, Aichi (JP)

(21) Appl. No.: 15/777,777

(22) PCT Filed: Jan. 10, 2017
(86) PCT No.: PCT/JP2017/000431

§ 371 Date: May 21, 2018

(30) Foreign Application Priority Data
Jan. 25, 2016 (JP) 2016-011680

(51) Int. Cl. B01F 3/04

(52) U.S. Cl. CPC B01F 3/04269; B01F 2003/0439; B01F 2003/04319

(57) ABSTRACT

An apparatus for generating fine-bubble-containing liquid is provided with: a plurality of bubble generating tubes each having a tubular shape extending in the longitudinal direction, each tube being configured such that at least a middle portion between one end and the other end of each tube is composed of porous ceramics to inject bubbles into a liquid that contacts the middle portion; a one-side support member that supports the one end of each of the bubble generating tubes; an other-side support member that supports the other end of each of the bubble generating tubes; and an interval keeping member that maintains the interval between the one-side support member and the other-side support member.

### TECHNICAL FIELD

The present invention relates to an apparatus for generating a liquid that contains fine bubbles (a fine-bubble-containing liquid), the apparatus being configured to inject fine bubbles into a liquid to produce the fine-bubble-containing liquid.

### BACKGROUND ART

In recent years, availability of a technique using fine bubbles called microbubbles or nanobubbles has received attention. For instance, this technique has been studied for utilization in a washing technique using a fine-bubble-containing liquid, water sterilization and deodorization, ozone water production, healthcare and medical equipment fields, clarification of water quality in lakes or hatcheries, various treatments of wastewater generated in industrial plants and animal husbandry, production of functional water, and others.

As an apparatus for generating the foregoing microbubbles and nanobubbles, some apparatuses including various structures have been proposed (see for example Patent Documents 1 to 3 and others).

### RELATED ART DOCUMENTS

### Patent Documents

Patent Document 1: JP-A-2011-224461

Patent Document 2: JP-A-2013-34976

Patent Document 3: JP-A-2009-101299

### SUMMARY OF INVENTION

### Problems to be Solved by the Invention

In particular, a bubble generating tube made of porous ceramics is configured to easily generate a fine-bubble-containing liquid in a simple manner that this bubble generating tube is immersed in a liquid and then pressurized gas is injected into the tube or that a liquid is caused to flow through this bubble generating tube and further pressurized gas is supplied to the outside of the tube, thereby feeding fine bubbles called microbubbles or nanobubbles into the liquid.

However, for injection of gas bubbles into a liquid, it is necessary to flow pressurized gas through a bubble generating tube (porous ceramics) in contact with the liquid (a flow passage). In this case, to inject a large amount of bubbles into a liquid, the pressure of gas has to be raised or the surface area of the bubble generating tube has to be increased. When the gas pressure is increased, each part or component needs corresponding strength. It is thus difficult to freely increase the gas pressure. Therefore, it is also conceivable to design a bubble generating tube with a long length to increase the surface area. However, the bubble generating tube with such a long length is low in strength and thus is hard to treat.

The present invention has been made to solve the above problems and has a purpose to provide an apparatus for generating a fine-bubble-containing liquid configured to generate a large amount of fine bubbles while using a bubble generating tube in which at least a middle portion is made of porous ceramics.

### Means of Solving the Problems

To achieve the above purpose, one aspect of the invention provides an apparatus for generating a fine-bubble-containing liquid, comprising: a plurality of bubble generating tubes, each having a tubular shape extending in a longitudinal direction, in which at least a middle portion between a one end portion and an other end portion of each tube is made of porous ceramics, and each bubble generating tube being configured to inject bubbles into a liquid that contacts the middle portion; a one-side support member supporting each of the one end portions of the plurality of bubble generating tubes; an other-side support member supporting each of the other end portions of the plurality of bubble generating tubes; and an interval keeping member keeping an interval between the one-side support member and the other-side support member.

In the fine-bubble-containing liquid generating apparatus according to the invention, the plurality of bubble generating tubes are supported between the one-side support member and the other-side support member. Specifically, there are provided the plurality of bubble generating tubes in parallel with each other between the one-side support member and the other-side support member. Accordingly, even though the apparatus includes the bubble generating tubes in each of which at least the middle portion is made of porous ceramics, the apparatus can provide increased surface areas of the bubble generating tubes (porous ceramics) to contact a liquid. This enables injection of more fine bubbles into the liquid. In addition, the bubble generating tubes can be designed to be shorter in length as compared with a configuration using a single long bubble generating tube. Accordingly, the fine-bubble-containing liquid generating apparatus can be achieved with high reliability and provided with the bubble generating tubes each having high strength.

Each of the bubble generating tubes is a bubble generating tube in which at least the middle portion (a middle part in the longitudinal direction) between the one end portion and the other end portion is made of porous ceramics, concretely, porous ceramics forming many gas paths connected with one another in a three-dimensional network pattern. One example is a bubble generating tube entirely made of porous ceramics. Other examples include a bubble generating tube having a middle portion (a middle part in the longitudinal direction) made of porous ceramics and a one end portion and the other end portion each made of dense ceramics, a tubular bubble generating tube entirely made of porous ceramics but having a one end portion and the other end portion made with no gas permeability in such a manner that the one end portion and the other end portion have been immersed with glass, resin, or the like to fill pores. Further, the tubular (cylindrical) bubble generating tube may be a straight tube having a cross section having a uniform shape over an axial direction, such as a circular tube and a rectangular tube, or a tapered tube tapering toward one side in the axial direction, such as a circular truncated cone-shaped tube and a truncated pyramid-shaped tube. In this regard, the circular tube having an annular cross section is preferable in terms of strength. Furthermore, the tubular (cylindrical) shape includes not only a shape being open at both ends but also a bottom-closed shape being closed at one end with a U-shaped or flat plate-shaped bottom.

The material of porous ceramics forming at least the middle portion of each bubble generating tube may include for example oxide ceramics such as alumina, titania, silica, mullite, and zirconia, nitride ceramics such as silicon nitride, and carbide ceramics such as silicon carbide.

Furthermore, the techniques for supporting the one end portion and the other end portion of each bubble generating tube with the one-side support member and the other-side support member may include a technique that a one-side end face of the one end portion of each bubble generating tube is pressed toward the other side in the longitudinal direction and the other-side end face of the other end portion of each bubble generating tube is pressed toward the one side in the longitudinal direction to hold each bubble generating tube from both sides in the longitudinal direction. An alternative is to hold the periphery of the one end portion and the periphery of the other end portion of each bubble generating tube. For pressing or holding the one end portion and the other end portion, the one-side support member is preferably placed by interposing a packing made of rubber such as natural rubber and silicon rubber or a packing made of fluorine resin such as PTFE.

The interval keeping member is a member for keeping the interval, or distance, between the one-side support member and the other-side support member. For example, in a fine-bubble-containing liquid generating apparatus configured to be immersed in a liquid stored in a container and supply gas into each bubble generating tube to inject fine bubbles from each bubble generating tube into the liquid in the container, the interval keeping member is embodied by a plurality of columnar members fixed to the one-side support member and the other-side support member and configured to keep the interval between the one-side support member and the other-side support member. As an alternative, in a fine-bubble-containing liquid generating apparatus configured to flow a liquid into a surrounding member that is placed between the one-side support member and the other-side support member and surrounds a plurality of bubble generating tubes, and pressurize the gas supplied to each bubble generating tube to inject fine bubbles into the liquid between the surrounding member and the bubble generating tubes, for example, the interval keeping member is embodied by the surrounding member that liquid-tightly surrounds the plurality of bubble generating tubes between the one-side support member and the other-side support member. As another alternative, in a fine-bubble-containing liquid generating apparatus configured to flow a liquid into each bubble generating tube and pressurize the gas supplied to the outside of each bubble generating tube to inject fine bubbles into the liquid in each tube, for example, the interval keeping member is embodied by the surrounding member that gas-tightly surrounds the plurality of bubble generating tubes between the one-side support member and the other-side support member.

The liquid to be produced as a fine-bubble-containing liquid by containing fine bubbles may include water-based solutions such as pure water, drinking water, sea water, various culture fluids, various aqueous solutions, and various sewage or wastewater, and various solutions such as organic solvent and oils. The gas contained as fine bubbles in a liquid may include various gases such as air, oxygen, ozone, chlorine gas, hydrogen, and nitrogen.

Furthermore, porous ceramics having a pore diameter D, defined by D(10)≤2 μm, is preferably used because it can efficiently generate fine bubbles having a diameter of 1 μm or less and inject such fine bubbles into a liquid. As a method for measuring a pore diameter distribution, a mercury intrusion technique is used. The term, D(10), indicates a pore diameter that ranks in the top 10% of a large-diameter side of the entire pore volume in an obtained accumulative pore diameter distribution curve.

In the aforementioned apparatus for generating a fine-bubble-containing liquid, preferably, in a cross section perpendicular to the longitudinal direction, the peripheral bubble generating tubes placed around the central bubble generating tube are arranged in rotational symmetry with respect to the central bubble generating tube, and the bubble generating tubes are arranged in a pattern that the bubble generating tubes are individually centered at apexes of imaginary equilateral triangles congruent with each other.

In order to support the plurality of bubble generating tubes with the one-side support member and the other-side support member and further gas-tightly or liquid-tightly hold each bubble generating tube between the one-side support member and the other-side support member, it is preferable that the plurality of bubble generating tubes are arranged with no deviation, i.e., in a balanced manner.

In this fine-bubble-containing liquid generating apparatus, the plurality of bubble generating tubes are arranged in a pattern satisfying the aforementioned condition. Thus, the plurality of bubble generating tubes can be placed around the central bubble generating tube in a balanced manner. Thus, the fine-bubble-containing liquid generating apparatus can be configured with the plurality of bubble generating tubes reliably supported with the one-side support member and the other-side support member.

Specifically, the fine-bubble-containing liquid generating apparatus may include a total of seven bubble generating tubes placed such that six peripheral bubble generating tubes are arranged in a regular hexagonal shape around a single central bubble generating tube. As an alternative, the fine-bubble-containing liquid generating apparatus may include a total of thirteen bubble generating tubes placed such that six peripheral bubble generating tubes are arranged in a regular hexagonal shape around a single central bubble generating tube and further six peripheral bubble generating tubes are arranged around the former six peripheral bubble generating tubes so that each of the latter six peripheral bubble generating tubes is located at an apex of an additional regular triangle having one side corresponding to one side of the former regular hexagon. As another alternative, the fine-bubble-containing liquid generating apparatus may include a total of nineteen bubble generating tubes placed such that six peripheral bubble generating tubes are arranged in a regular hexagonal shape around a single central bubble generating tube and further six peripheral bubble generating tubes are arranged in a regular hexagonal shape around the former six peripheral bubble generating tubes and still further twelve peripheral bubble generating tubes. As another alternative, the fine-bubble-containing liquid generating apparatus may include a total of thirty-one bubble generating tubes placed such that six peripheral bubble generating tubes are arranged in a regular hexagonal shape around a single central bubble generating tube, twelve peripheral bubble generating tubes are arranged around the six peripheral bubble generating tubes, and further twelve peripheral bubble generating tubes are arranged around the former twelve peripheral bubble generating tubes. As still another alternative, the fine-bubble-containing liquid generating apparatus may include a total of forty-three bubble generating tubes placed such that six peripheral bubble generating tubes are arranged in a regular hexagonal shape around a single central bubble generating tube, twelve peripheral bubble generating tubes are arranged around the six peripheral bubble generating tubes, and further twenty-four peripheral bubble generating tubes are arranged around the twelve peripheral bubble generating tubes.

In the aforementioned fine-bubble-containing liquid generating apparatus, moreover, it is preferable that any part or portion that comes in contact with the liquid is made of non-metal.

In a case where fine bubbles are to be contained in pure water or various chemical solutions to be used in a production line for semiconductors, if a fine bubble generating tool includes an exposed, or uncovered, metal material, a defect that metal ions are eluted in a liquid may take place. In contrast, in the aforementioned fine-bubble-containing liquid generating apparatus, any part or portion that comes into contact with the liquid is made of non-metal, any defect that metal ions are eluted in a liquid does not take place.

The non-metal materials may include for example ceramics such as alumina, titania, mullite, zirconia, and silicon nitride, fluorine resin such as PTFE and PFA, and further thermoplastic resin such as PE, PP, ABS, PET, and acrylic. There can be used not only a member(s) made of the above materials but also a member including a portion which comes into contact with a liquid and is made of metal material and applied with lining of fluorine resin or the like.

Furthermore, in the apparatus for generating a fine-bubble-containing liquid described in any one of the above aspects, preferably, the one-side support member includes: a liquid inflow part forming a liquid inlet in which the liquid flows; and a liquid distribution part forming a liquid distribution pathway to distribute the liquid having flowed in the one-side support member to the one end portions of the plurality of bubble generating tubes, the other-side support member includes: a liquid outflow part forming a liquid outlet from which the fine-bubble-containing liquid flows out; and a collecting pathway part forming a liquid collecting pathway to direct the fine-bubble-containing liquid having flowed out through the other end portions of the plurality of bubble generating tubes toward the liquid outlet, and the interval keeping member includes: a tube surrounding part having a tubular shape and gas-tightly surrounding around the plurality of bubble generating tubes between the one-side support member and the other-side support member; and a gas inflow part forming a gas inlet to direct pressurized gas into the tube surrounding part.

In this fine-bubble-containing liquid generating apparatus configured to flow a liquid into the plurality of bubble generating tubes, when gas bubbles are to be injected into the liquid, the liquid is not exposed to outside air and thus the liquid can be generated as a fine-bubble-containing liquid in a clean state.

Alternatively, in the apparatus for generating a fine-bubble-containing liquid described in any one of the above aspects, preferably, the one-side support member includes: a gas inflow part forming a gas inlet in which pressurized gas flows; and a gas distribution part forming a gas distribution pathway to distribute the gas having flowed in the one-side support member to the one end portions of the plurality of bubble generating tubes, the interval keeping member includes: a tube surrounding part having a tubular shape and gas-tightly surrounding around the plurality of bubble generating tubes between the one-side support member and the other-side support member, and the generating apparatus is provided with a liquid inflow part and a liquid outflow part in a configuration to allow the liquid to flow in between the plurality of bubble generating tubes and the tube surrounding part, allow the liquid having flowed therein to flow in the longitudinal direction along the middle portions of the bubble generating tubes, and allow the fine-bubble-containing liquid to flow out of the tube surrounding part.

In the aforementioned fine-bubble-containing liquid generating apparatus configured to allow the liquid to flow on the outside of the plurality of bubble generating tubes, similarly, when gas bubbles are to be injected into a liquid, the liquid is not exposed to outside air and thus the liquid can be generated as a fine-bubble-containing liquid in a clean state. In the fine-bubble-containing liquid generating apparatus of this type of allowing a liquid to flow on the outside of a tube so that the liquid contacts an outer surface of the middle portion of each bubble generating tube. Thus, as compared with an apparatus of a type of allowing a liquid to flow on the inside of each bubble generating tube so that a liquid contacts an inner surface of each bubble generating tube, the aforementioned apparatus configured to flow the liquid outside the tubes can provide relatively increased surface areas of the bubble generating tubes (porous ceramics) to contact a liquid. Therefore, the apparatus can relatively efficiently inject fine bubbles into the liquid. Further, the liquid inflow part and the liquid outflow part may be provided to allow a liquid to flow in between the plurality of bubble generating tubes and the tube surrounding part, allow the liquid having flowed therein to flow in the longitudinal direction along the middle portions of the bubble generating tubes, and allow the fine-bubble-containing liquid to flow out of the tube surrounding part. For instance, the liquid inflow part and the liquid outflow part may be provided in the tube surrounding part of the interval keeping member. As an alternative, it may be configured that the liquid inflow part is provided in the one-side support member and the liquid outflow part is provided in the other-side support member. As another alternative, to the contrary, it may be configured that the liquid inflow part is provided in the other-side support member and the liquid outflow part is provided in the one-side support member.

Such a fine-bubble-containing liquid generating apparatus may include a fine-bubble-containing liquid generating apparatus configured that the interval keeping member includes the tube surrounding part and further the liquid inflow part is provided in a portion on one side or the other side of the tube surrounding part in the longitudinal direction, and the liquid outflow part is provided in an opposite portion on the other side or the one side of the tube surrounding part to the liquid inflow part in the longitudinal direction.

In this fine-bubble-containing liquid generating apparatus, the liquid inflow part and the liquid outflow part are provided in the tube surrounding part of the interval keeping member, so that those liquid inflow part and liquid outflow part can be easily provided with a simple structure. In addition, the liquid inflow part and the liquid outflow part are placed on opposite sides in the longitudinal direction, that is, in separated positions from each other. Thus, the liquid having flowed therein is allowed to flow along the bubble generating tubes and fine bubbles can be injected appropriately into the liquid.

### BRIEF DESCRIPTION OF THE DRAWINGS

FIG. 1 is a cross-sectional explanatory view showing a structure of an apparatus for generating a fine-bubble-containing liquid using a plurality of bubble generating tubes in a first embodiment;

FIG. 2 is an explanatory view showing arrangement of the plurality of bubble generating tubes (13 tubes) in the first embodiment;

FIG. 3 is an explanatory view showing a positional relationship between the bubble generating tubes in the first embodiment, a second embodiment, and a third embodiment;

FIG. 4 is an explanatory view showing a usage example of the apparatus for generating a fine-bubble-containing liquid in the first embodiment;

FIG. 5 is a cross-sectional explanatory view showing a structure of an apparatus for generating a fine-bubble-containing liquid using a plurality of bubble generating tubes in a second embodiment;

FIG. 6 is an explanatory view showing arrangement of the plurality of bubble generating tubes (13 tubes) in the second embodiment;

FIG. 7 is a cross-sectional explanatory view showing a structure of an apparatus for generating a fine-bubble-containing liquid using a plurality of bubble generating tubes in a third embodiment; and

FIG. 8 is an explanatory view showing arrangement of the plurality of bubble generating tubes (13 tubes) in the third embodiment.

### MODE FOR CARRYING OUT THE INVENTION

### First Embodiment

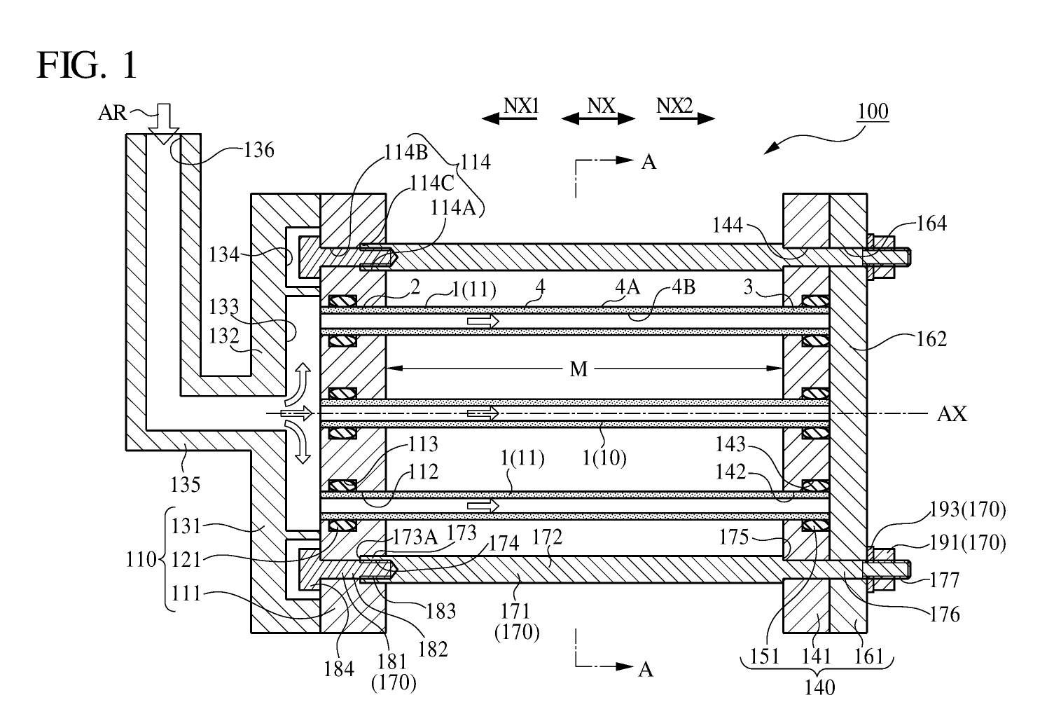

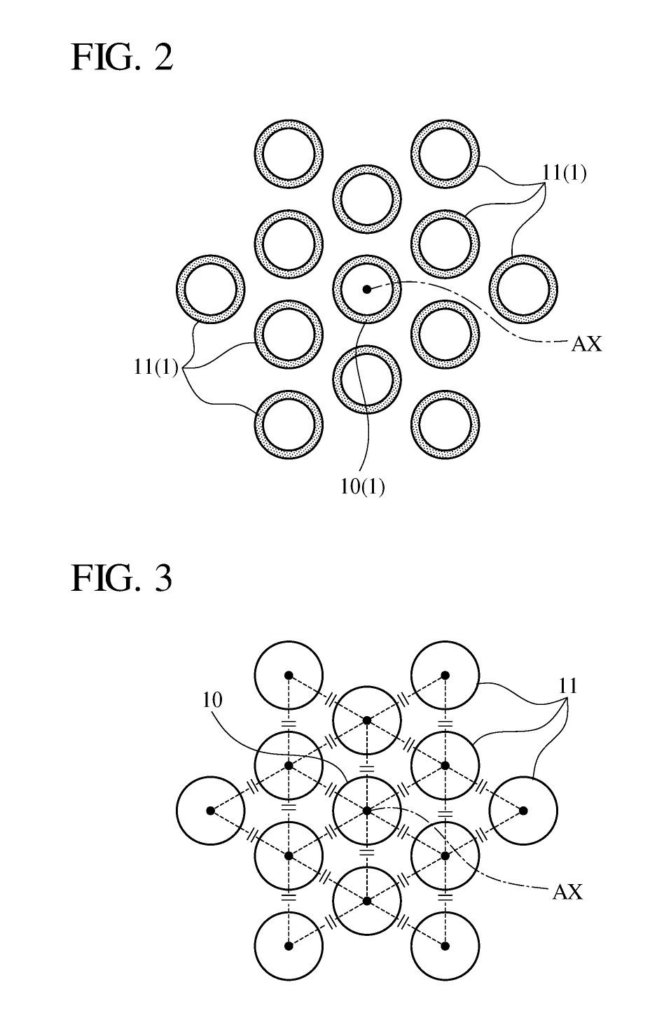

A detailed description of a first embodiment will now be given referring to FIGS. 1 to 4. FIG. 1 is a cross-sectional explanatory view schematically showing a cross-sectional structure of an apparatus 100 for generating a fine-bubble-containing liquid (hereinafter, also simply referred to as a generating apparatus). FIG. 2 is an explanatory view showing an arrangement state of thirteen bubble generating tubes 1.

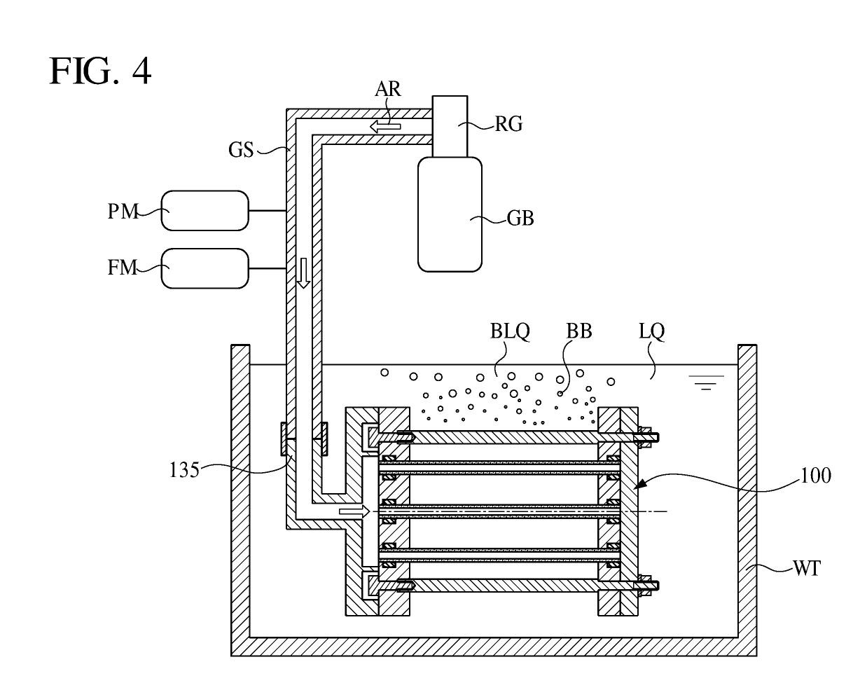

The generating apparatus 100 in the first embodiment will be used in such a way that it is immersed in a liquid LQ (e.g., water) stored in a tank WT, for example as shown in FIG. 4, to make the liquid LQ into a fine-bubble-containing liquid BLQ. Specifically, the generating apparatus 100 takes in gas AR (e.g., air) through a gas inflow part 135 connected to a gas pipe GS, the gas AR having been fed from a gas cylinder GB and pressure-regulated to a gauge pressure of about 2 atmospheres (atm) by a regulator RG. Then, this gas AR is delivered to each of a plurality of bubble generating tubes 1. Accordingly, fine bubbles formed of the gas AR are injected into the liquid LQ externally contacting these bubble generating tubes 1. The pressure of gas AR is measured by a pressure gauge PM and the flow rate of the gas AR flowing through the gas pipe GS is measured by a flow meter FM.

The generating apparatus 100 is provided with the plurality of bubble generating tubes 1 (13 tubes in the first embodiment), a one-side support member 110 supporting each of one end portions 2 (left end portions in FIG. 1) of the bubble generating tubes 1, an other-side support member 140 supporting each of other end portions 3 (right end portions in FIG. 1) of the bubble generating tubes 1, and an interval keeping member 170 for keeping the interval, or distance, between the one-side support member 110 and the other-side support member 140.

The bubble generating tubes 1 are each made of porous alumina in a straight circular tube shape having a circular cross section. In each bubble generating tube 1, a left portion in FIG. 1 is referred to as a one end portion 2, a right end portion in FIG. 1 is referred to as an other end portion 3, and an intermediate portion between the one end portion 2 and the other end portion 3 is referred to as a middle portion 4. Assuming that in a pore diameter distribution measured by use of a mercury intrusion technique (JIS R1655), pore diameter values that rank in the top 10% on a large-diameter side in this pore diameter distribution are expressed as D(10), each bubble generating tube 1 is made of porous alumina having a pore diameter D(10) being 2 μm or less. To be concrete, in the first embodiment, D(10)=1.4 μm. Therefore, when the gas AR at a gauge pressure of about 1.5 atm is injected into this bubble generating tube 1, fine bubbles BB containing bubbles of 1 μm or less in diameter can be injected into the liquid LQ being outside the tubes. As will be described later, even in a case where the gas AR at a gauge pressure of about 1.5 atm is injected to the outside of the bubble generating tube 1 and the liquid LQ is fed into the bubble generating tube 1, similarly, the bubble generating tube 1 can inject fine bubbles BB containing bubbles of 1 μm or less into the liquid LQ.

Of each of the bubble generating tubes 1, the one end portion 2 is supported by the one-side support member 110 and the other end portion 3 is supported by the other-side support member 140 (see FIG. 1). The one-side support member 110 includes a one-side holder 111 having a nearly circular disc-like shape, first packings 121, and a one-side cover member 131 covering the one-side holder 111 from one side NX1 in a longitudinal direction NX.

The one-side holder 111 made of stainless material formed therethrough with thirteen generating-tube insertion holes 112 in which the one end portions 2 of the bubble generating tubes I are individually inserted, the generating-tube insertion holes 112 being arranged in predetermined positions around an axis AX as will be described later. Each of the generating-tube insertion holes 112 is provided with a packing groove 113 annularly extending with a larger diameter than each generating-tube insertion hole 112. In each packing groove 113, one first packing 121 (an O-ring) made of ethylene-propylene rubber (EPDM) is mounted. Accordingly, since the one end portions 2 of the bubble generating tubes 1 are inserted in the corresponding generating-tube insertion holes 112, the one end portions 2 of the bubble generating tubes 1 can be gas-tightly and liquid-tightly retained in the one-side holder 111 through the first packings 121 while gas AR is fed from a portion of the one-side holder 111 on a one side NX1 into each of the bubble generating tubes 1, as will be described later.

A peripheral portion of the one-side holder 111 is formed with column stop holes 114 at six positions to allow insertion of one end portions 173 provided on one side of each column member 171 (the interval keeping member 170) mentioned later and bolts 181 for tightening the column members 171 to fasten and fix the column members 171 to the one-side holder 111. Each of the column stop hole 114 includes a column insertion part 114A having a relatively large diameter for receiving the one end portion 173 of each column member 171, a bolt insertion part 114B having a relatively small diameter for allowing insertion of a shaft portion 182 of the bolt 181, and an engagement stepped part 114C formed in stepwise shape between the column insertion part 114A and the bolt insertion part 114B and configured to allow a one end face 173A of the column member 171 to abut on the stepped part 114C into engagement therewith.

The one-side cover member 131 made of stainless steel includes a gas distribution part 132 and a gas inflow part 135. A gas inlet 136 formed in this gas inflow part 135 is connected to a gas pipe GS (see FIG. 4) and others to allow the gas AR pressurized to a gauge pressure of for example about 1.5 atm to flow therein. Further, the gas distribution part 132 is provided with a gas distribution recess 133 recessed over a range that faces the generating-tube insertion holes 112, i.e., a range that faces the one end portions 2 of the bubble generating tubes 1 inserted in the one-side holder 111. Through the gas distribution recess 133 forming a gas distribution pathway, the gas AR having flowed therein through the gas inflow part 135 is distributed into each bubble generating tube 1 (each one end portion 2), as indicated by hollow arrows in FIG. 1.

Further, the one-side cover member 131 is provided, outside of the gas distribution recess 133 (above and below in FIG. 1), with bolt accommodating recesses 134 for accommodating heads 184 of the aforementioned bolts 181 to avoid interference with the one-side cover member 131. The one-side holder 111 and the one-side cover member 131 are integrally fastened in the longitudinal direction NX with bolts not shown.

In contrast, the other-side support member 140 includes an other-side holder 141 having a nearly circular disc-like shape, second packings 151, and an other-side cover member 161 covering the other-side holder 141 from the other side NX2 in the longitudinal direction NX.

The other-side holder 141 made of stainless material includes thirteen generating-tube insertion holes 142 in which the other end portions 3 of the bubble generating tubes 1 are individually inserted, the generating-tube insertion holes 142 being arranged in predetermined positions around the axis AX as will be described later. Each of the generating-tube insertion holes 142 is provided with a packing groove 143 annularly extending with a larger diameter than each generating-tube insertion hole 142. In each packing groove 143, one second packing 151 (an O-ring) made of EPDM is mounted. Accordingly, since the other end portions 3 of the bubble generating tubes 1 are inserted in the corresponding generating-tube insertion holes 142, the other end portions 3 of the bubble generating tubes 1 are gas-tightly and liquid-tightly retained in the other-side holder 141 through the second packings 151 when gas AR is fed from a portion of the one-side holder 111 on the one side NX1 into each of the bubble generating tubes 1.

A peripheral portion of the other-side holder 141 is formed with column insertion holes 144 at six positions to allow insertion of other end portions 176 provided on the other side of each after-mentioned column member 171. The other end portion 176 of each column member 171 inserted in each column insertion hole 144 is formed with an external thread part 177 with which a nut 191 is screwed through a washer 193 to lock the other end portions 176 of the column members 171 to the peripheral portions of column insertion holes 164 of the other-side cover member 161 which will be mentioned later.

The other-side cover member 161 made of stainless material includes, as a central part, an other-end portion cover part 162 on which the other end portions 3 of the bubble generating tubes 1 inserted in the generating-tube insertion holes 142 of the other-side holder 141 are abutted.

Further, the other-side cover member 161 is formed, outside of the other-end portion cover part 162 in a radial direction (in an up-and-down direction in FIG. 1), with column insertion holes 164 in which other end portions 176 of the aforementioned column members 171 are inserted, the column insertion holes 164 being arranged in positions coaxially aligned with the column insertion holes 144 of the other-side holder 141. The other-side holder 141 and the other-side cover member 161 are fixed to each other with the column members 171 inserted through the column insertion holes 144 and the column insertion holes 164.

In the first embodiment, the interval keeping member 170 for keeping the interval between the one-side support member 110 and the other-side support member 140 includes six sets of the column members 171, bolts 181, nuts 191, and washers 193. Each of the column members 171 made of stainless steel includes a column body part 172 having a nearly columnar shape, a one end portion 173 internally formed with an internal thread hole 174, and an other end portion 176 having a smaller diameter than the column body part 712 and including an external thread part 177 provided at a distal end. An engagement stepped portion 175 formed in stepwise shape is provided between the column body part 172 and the other end portion 176.

As described above, the one end portions 173 of the column members 171 are inserted in the column insertion parts 114A of the one-side holder 111 and secured to the one-side holder 111 with the bolts 181 (an external thread part 183 of each shaft 182) screwed into the internal thread parts 174 while the one end faces 173A of the one end portions 173 abut on the engagement stepped portions 114C. Furthermore, the other end portions 176 of the column members 171 are inserted in the column insertion holes 144 of the other-side holder 141 and the column insertion holes 164 of the other-side cover member 161 and further the external thread parts 177 are screwed together with the nuts 191. Thus, the other-side holder 141 and the other-side cover member 161 are tightly fixed to each other by the engagement stepped portions 175 engaging with the other-side holder 141 and the nuts 191 engaging with the other-side cover member 161. Accordingly, the interval M between the one-side support member 110 and the other-side support member 140 is limited to a predetermined dimension.

The following explanation will be given to the arrangement of thirteen bubble generating tubes 1 in the generating apparatus 100 in the first embodiment with reference to FIG. 2 and FIG. 3. This FIG. 2 shows only each end face of the thirteen bubble generating tubes 1 in a cross section of the generating apparatus 100 taken along a line A-A in FIG. 1. Those thirteen bubble generating tubes 1 are arranged as below. Specifically, one of the thirteen bubble generating tubes 1 is placed as a central bubble generating tube 10 and, around its axis AX, six bubble generating tubes 1 (peripheral bubble generating tubes 11) are arranged with their centers being located at apexes of an imaginary regular hexagon. Accordingly, those seven bubble generating tubes 1 are arranged in rotational symmetry at angular intervals of 60 degrees around the axis AX and arranged in a pattern that the bubble generating tubes 1 are individually centered at apexes of imaginary equilateral triangles congruent with each other (see FIG. 3).

Furthermore, the remaining six peripheral bubble generating tubes 11 are placed in positions such that each side of the imaginary hexagon forms one side of each additional regular triangle. Accordingly, the arrangement shown in FIG. 2 is achieved. Those thirteen bubble generating tubes 1 are also arranged in rotational symmetry at angular intervals of 60 degrees around the axis AX and arranged in a pattern that the bubble generating tubes 1 are individually centered at apexes of imaginary congruent equilateral triangles (see FIG. 3). Since the plurality of bubble generating tubes 1 are arranged in the above configuration, the bubble generating tubes 1 can be placed in a balanced manner around the central bubble generating tube 10. Thus, the generating apparatus 100 can be configured such that the plurality of bubble generating tubes 1 are reliably supported by the one-side support member 110 (the one-side holder 111) and the other-side support member 140 (the other-side holder 141). Similarly, the number of bubble generating tubes 1 can also be set to 19, 31, and others.

For instance, when the the generating apparatus 100 in the first embodiment is immersed in the liquid LQ stored in a tank WT and the gas AR is fed into the bubble generating tubes 1 through the inflow part 135 as described above, fine bubbles BB can be generated from those bubble generating tubes 1 (the middle portions 4) to inject the fine bubbles BB into the liquid LQ. In this generating apparatus 100, the plurality of bubble generating tubes 1 (thirteen bubble generating tubes in the first embodiment) are used to distribute the gas AR into each bubble generating tube 1. This enables generation of fine bubbles BB from each of the middle portions 4 of the bubble generating tubes 1. Specifically, the generating apparatus 100 can provide increased surface areas of the middle portions 4 (porous ceramics) of the bubble generating tubes 1 to contact the liquid LQ and accordingly can inject more fine bubbles BB into the liquid LQ. In addition, the bubble generating tubes 1 can be designed to be shorter in length as compared with a configuration using a single long bubble generating tube. Thus, the generating apparatus 100 for generating a fine-bubble-containing liquid BLQ can be achieved with high reliability and provided with bubble generating tubes 1 each having high strength.

### Second Embodiment

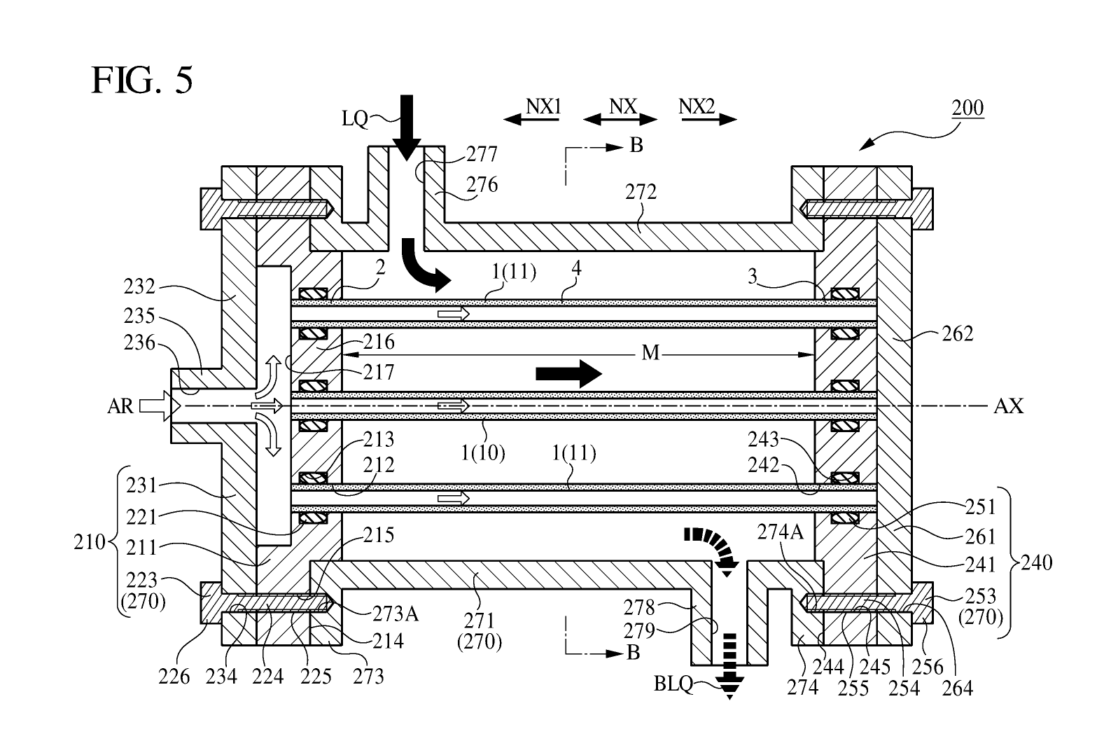

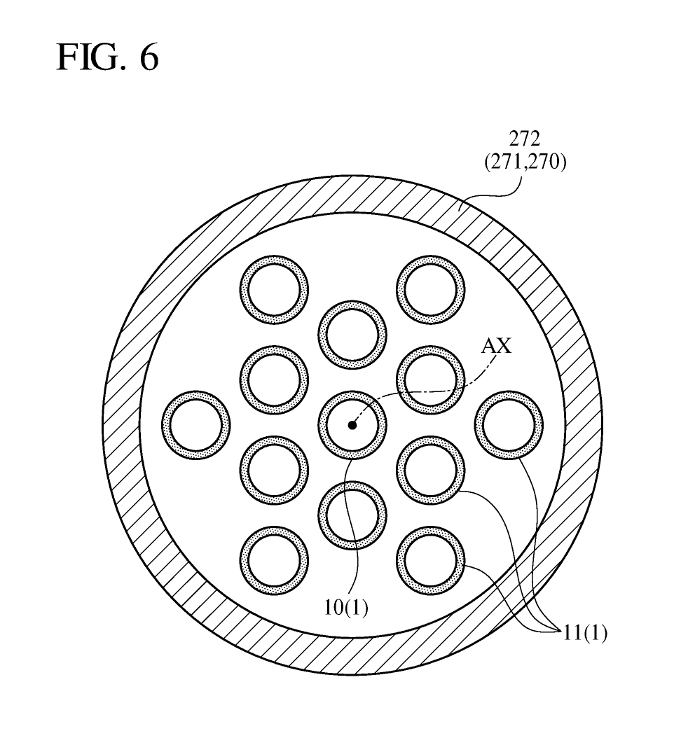

Next, a generating apparatus 200 in a second embodiment will be described with reference to FIGS. 5 and 6. FIG. 5 is a cross-sectional explanatory view schematically showing a cross-sectional structure of the generating apparatus 200 in the second embodiment. The generating apparatus 100 in the aforementioned first embodiment is a generating apparatus (of immersion type) configured to be used in such a way that it is immersed in the liquid LQ stored in the tank WT. In contrast, the generating apparatus 200 in the second embodiment is similar to the first embodiment in feeding the gas AR into the bubble generating tubes 1 but differs from the first embodiment in that the plurality of bubble generating tubes 1 are surrounded by a tube surrounding member 271 and a liquid LQ is allowed to flow in between the bubble generating tubes 1 and the tube surrounding member 271 to flow a fine-bubble-containing liquid BLQ out therefrom.

The generating apparatus 200 includes the plurality of bubble generating tubes 1 (thirteen bubble generating tubes in the first embodiment), a one-side support member 210 supporting each of the one end portions 2 (left end portions in FIG. 5) of the bubble generating tubes 1, an other-side support member 240 supporting each of the other end portions 3 (right end portions in FIG. 5) of the bubble generating tubes 1, and an interval keeping member 270 for keeping the interval, or distance, between the one-side support member 210 and the other-side support member 240. The bubble generating tubes 1 (10 and 11) and their arrangements are identical to those in the first embodiment and thus their explanation is omitted (see FIGS. 2 and 6).

Of each of the bubble generating tubes 1, the one end portion 2 is supported by the one-side support member 210 and the other end portion 3 is supported by the other-side support member 240 (see FIG. 5). The one-side support member 210 includes a one-side holder 211 having a nearly circular disc-like shape, first packings 221, and a one-side cover member 231 covering the one-side holder 211 from the one side NX1 in the longitudinal direction NX.

The one-side holder 211 made of stainless material includes a gas distribution part 216 formed therethrough with thirteen generating-tube insertion holes 212 in which the one end portions 2 of the bubble generating tubes 1 are individually inserted. The generating-tube insertion holes 212 are placed in correspondence to the positions of the thirteen bubble generating tubes 1 (10, 11) (see FIG. 6) arranged in predetermined positions around the axis AX as in the first embodiment. Each of the generating-tube insertion holes 212 is provided with a packing groove 213 annularly extending with a larger diameter than each generating-tube insertion hole 212. In each packing groove 213, one first packing 221 (an O-ring) made of EPDM is mounted. Accordingly, since the one end portions 2 of the bubble generating tubes 1 are inserted in the corresponding generating-tube insertion holes 212, the one end portions 2 of the bubble generating tubes 1 can be gas-tightly and liquid-tightly retained in the one-side holder 211 through the first packings 221 while the gas AR is fed from a portion of the one-side holder 211 on the one side NX1 into each of the bubble generating tubes 1.

A peripheral portion of the one-side holder 211 is formed with a stepwise cutout, forming a locking stepped portion 214 in which a first flange 273 formed on one side of an after-mentioned tube surrounding member 271 (the interval keeping member 270) is fitted and locked. Further, as described later, the one-side holder 211 is further formed with six bolt insertion holes 215 in six positions through which shafts 224 of bolts 223 are inserted to fasten the one-side cover member 231, the one-side holder 211, and the first flange 273 of the tube surrounding member 271.

Further, the gas distribution part 216 is provided with a gas distribution recess 217 recessed over a range in which the generating-tube insertion holes 212 exist, that is, a range in which the one end portions 2 of the bubble generating tubes 1 are exposed. Through the gas distribution recess 217 forming a gas distribution pathway, the gas AR having flowed therein through a gas inflow part 235 mentioned later is distributed into each bubble generating tube 1 (each one end portion 2), as indicated by hollow arrows in FIG. 5.

The one-side cover member 231 made of stainless material includes a one-end portion cover part 232 of a circular disc-like shape and the gas inflow part 235 protruding from the center of the cover part 232 toward the one side NX1 in the longitudinal direction. A gas inlet 236 formed in the gas inflow part 235 is connected to a gas pipe (not shown) or the like to allow the gas AR pressurized to a gauge pressure of for example 1.5 atm to flow therein. The one-end portion cover part 232 covers the one end portions 2 of the bubble generating tubes 1 so that the gas distribution recess 217 forms a space between the cover part 232 and the gas distribution part 216 of the one-side holder 211 to deliver the gas AR having flowed therein to each bubble generating tube 1. Furthermore, a peripheral portion of the one-side cover member 231 also includes bolt insertion holes 234 formed in six positions coaxially aligned with the bolt insertion holes 215 of the one-side holder 211 so that the shafts 224 of the bolts 223 are inserted through the bolt insertion holes 234.

On the other hand, the other-side support member 240 includes an other-side holder 241, second packings 251, and an other-side cover member 261 having a nearly circular disc-like shape and covering the other-side holder 241 from the other side NX2 in the longitudinal direction NX,

The other-side holder 241 made of stainless material includes thirteen generating-tube insertion holes 242 in which the other end portions 3 of the bubble generating tubes 1 are individually inserted, the generating-tube insertion holes 242 being placed in predetermined positions around the axis AX in correspondence with the thirteen bubble generating tubes 1 (10 and 11) (see FIG. 6). Each of the generating-tube insertion holes 242 is provided with a packing groove 243 annularly extending with a larger diameter than each generating-tube insertion hole 242. In each packing groove 243, one second packing 251 (an O-ring) made of EPDM is mounted. Accordingly, since the other end portions 3 of the bubble generating tubes 1 are inserted in the generating-tube insertion holes 242, the other end portions 3 of the bubble generating tubes 1 are gas-tightly and liquid-tightly retained in the other-side holder 241 through the second packings 251.

A peripheral portion of the other-side holder 241 is formed with a stepwise cutout, forming a locking stepped portion 244 in which a second flange 274 formed on the other side of the after-mentioned tube surrounding member 271 is fitted and locked. Further, as described later, the other-side holder 241 is further formed with bolt insertion holes 245 in six positions through which shafts 254 of bolts 253 are inserted to fasten the other-side cover member 261, the other-side holder 241, and the second flange 274 of the tube surrounding member 271.

The other-side cover member 261 made of stainless material includes, as a central part, an other-end portion cover part 262 on which the other end portions 3 of the bubble generating tubes 1 inserted in the generating-tube insertion holes 242 of the other-side holder 241 are abutted. Further, a peripheral portion of the other-side cover member 261 also includes bolt insertion holes 264 formed in six positions coaxially aligned with the bolt insertion holes 245 of the other-side holder 241 so that the shafts 254 of the bolts 253 are inserted through the bolt insertion holes 264.

In the second embodiment, the interval keeping member 270 for keeping the interval between the one-side support member 210 and the other-side support member 240 includes the tube surrounding member 271, the bolts 223, and the bolts 253. The tubular tube surrounding member 271 made of stainless steel includes a tube surrounding part 272 having a tubular shape and surrounding around the thirteen bubble generating tubes 1 and further the first flange 273 extending radially outward from an end of the tube surrounding part 272 on the one side NX1 in the longitudinal direction, and the second flange 274 extending radially outward from an end of the tube surrounding part 272 on the other side NX2 in the longitudinal direction. The tube surrounding part 272 is provided with a liquid inflow part 276 protruding outward and forming a liquid inlet 277, the liquid inflow part 276 being located in a position on the one side NX1 (a left side in FIG. 5) in the longitudinal direction. The tube surrounding part 272 is further provided with a liquid outflow part 278 protruding outward and forming a liquid outlet 279, the liquid outflow part 278 being located in a position on the other side NX2 (a right side in FIG. 5), opposite to the liquid inflow part 276.

This first flange 273 of the tube surrounding member 271 is fitted on the locking stepped portion 214 of the one-side holder 211 and further external thread parts 225 of the bolts 223 inserted through the bolt insertion holes 234 of the one-side cover member 231 and the bolt insertion holes 215 of the one-side holder 211 are screwed in corresponding internal thread holes 273A of the first flange 273 to fasten together the one-side cover member 231, the one-side holder 211, and the tube surrounding member 271 (the first flange 273). Further, the second flange 274 of the tube surrounding member 271 is fitted on the locking stepped portion 244 of the other-side holder 241 and further external thread parts 255 of the bolts 253 inserted through the bolt insertion holes 264 of the other-side cover member 261 and the bolt insertion holes 245 of the other-side holder 241 are screwed in corresponding internal thread holes 274A of the second flange 274 to fasten together the other-side cover member 261, the other-side holder 241, and the tube surrounding member 271 (the second flange 274). With this tube surrounding member 271, the interval M between the one-side support member 210 and the other-side support member 240 is limited to a predetermined dimension.

The following explanation will be given to the arrangement of thirteen bubble generating tubes 1 in the generating apparatus 200 in the second embodiment with reference to FIG. 6 and FIG. 3. This FIG. 6 shows only each end face of the thirteen bubble generating tubes 1 and the tube surrounding member 271 (the tube surrounding part 272) in a cross section of the generating apparatus 200 taken along a line B-B in FIG. 5. The arrangement of the thirteen bubble generating tubes 1 is identical to that in the first embodiment and thus its explanation is omitted. The thirteen bubble generating tubes 1 are arranged in rotational symmetry at angular intervals of 60 degrees around the axis AX and arranged in a pattern that the bubble generating tubes 1 are individually centered at apexes of imaginary equilateral triangles congruent with each other (see FIG. 3). Since the plurality of bubble generating tubes 1 are arranged in the above configuration, the bubble generating tubes 1 can be placed in a balanced manner around the central bubble generating tube 10. Thus, the generating apparatus 200 can be configured such that the plurality of bubble generating tubes 1 are reliably supported by the one-side support member 210 (the one-side holder 211) and the other-side support member 240 (the other-side holder 241).

The generating apparatus 200 in the second embodiment is configured, as shown in FIG. 5, to feed the gas AR into the bubble generating tubes 1 through the gas inflow part 235, while flowing the liquid LQ into the tube surrounding part 272 (between the bubble generating tubes 1 and the tube surrounding part 272) through the liquid inflow part 276 and further causing the fine-bubble-containing liquid BLQ to flow out of the tube surrounding part 272 through the liquid outflow part 278. The liquid LQ having flowed in the tube surrounding part 272 flows through the outside of each bubble generating tube 1 in the longitudinal direction NX (in the second embodiment, toward the other side NX2 in the longitudinal direction (i.e., rightward in the figure)) along the middle portions 4 of the bubble generating tubes 1 and further flows out through the liquid outflow part 278. While the liquid LQ flows through the inside of the tube surrounding part 272, fine bubbles BB are generated from the middle portions 4 of the bubble generating tubes 1 and injected into the liquid LQ.

In this generating apparatus 200, the plurality of bubble generating tubes 1 (thirteen bubble generating tubes in the first embodiment) are used to distribute gas AR into each of the bubble generating tubes 1. This enables generation of fine bubbles BB from each of the middle portions 4 of the bubble generating tubes 1. Specifically, the generating apparatus 200 can provide increased surface areas of the middle portions 4 (porous ceramics) of the bubble generating tubes 1 to contact the liquid LQ and thus inject more fine bubbles BB into the liquid LQ. In addition, the bubble generating tubes can be designed to be shorter in length as compared with a configuration using a single long bubble generating tube. Thus, the generating apparatus 200 for generating a fine-bubble-containing liquid BLQ can be achieved with high reliability and provided with the bubble generating tubes 1 each having high strength.

Furthermore, in the generating apparatus 200 in the second embodiment, when fine bubbles BB of gas AR are injected into the liquid LQ, the liquid LQ is not exposed to outside air. Therefore, the liquid LQ in a clean state can be made into a fine-bubble-containing liquid BLQ. The generating apparatus 200 in the second embodiment is configured such that the liquid LQ contacts the outer surfaces of the middle portions 4 of the bubble generating tubes 1. Accordingly, as compared with a generating apparatus 300 of a third embodiment mentioned later in which a liquid LQ contacts the inner surfaces of the bubble generating tubes 1, the generating apparatus 200 can provide relatively increased surface areas of the middle portions 4 of the bubble generating tubes 1 to contact the liquid. Thus, as an advantage, the generating apparatus 200 can relatively efficiently inject fine bubbles BB into the liquid LQ.

### Third Embodiment

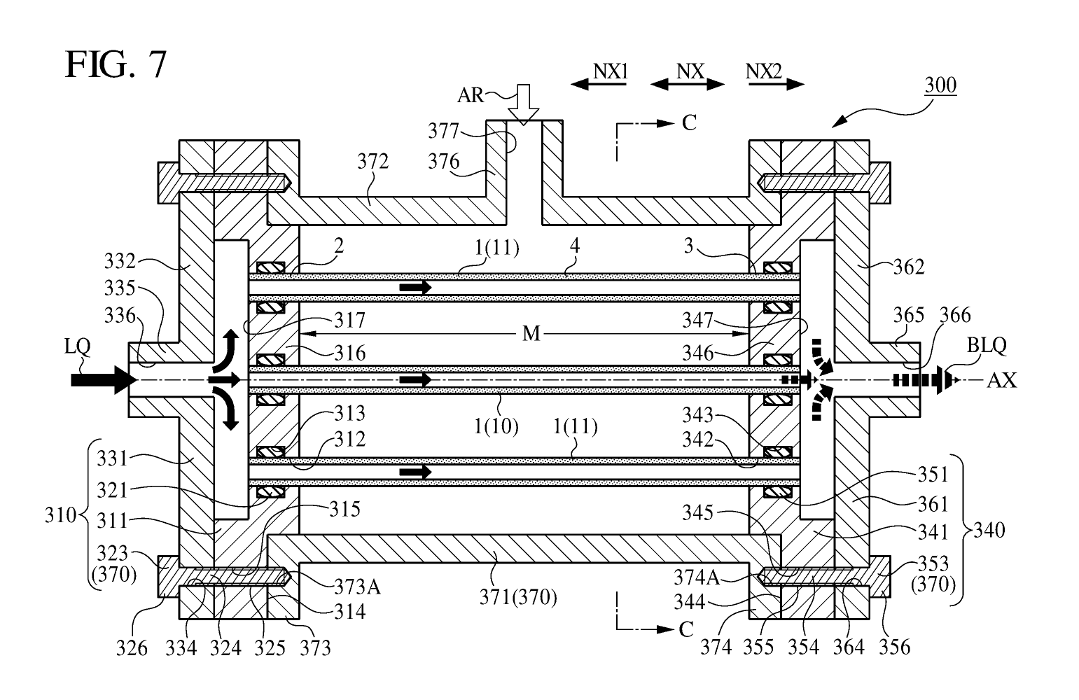

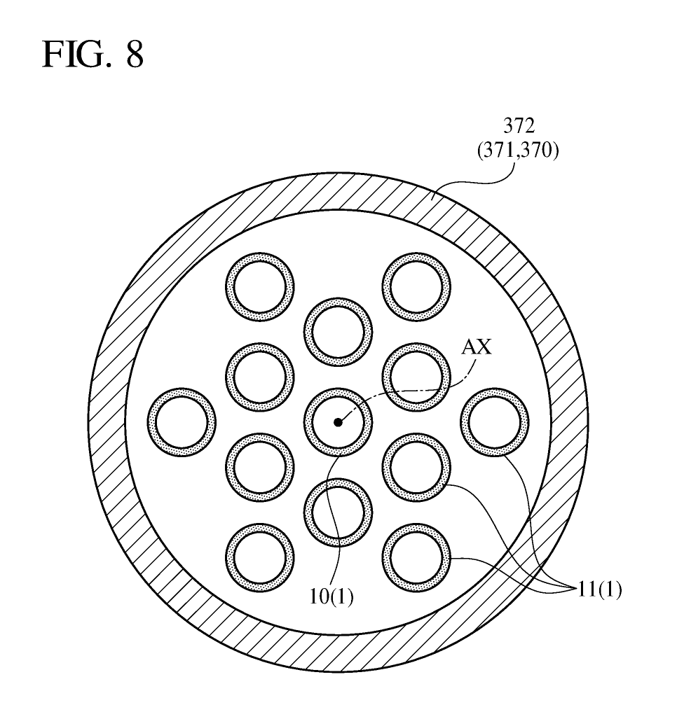

Next, a generating apparatus 300 in a third embodiment will be described with reference to FIGS. 7 and 8. FIG. 7 is a cross sectional explanatory view schematically showing a cross-sectional structure of the generating apparatus 300 in the third embodiment. The generating apparatus 200 in the aforementioned second embodiment is configured to feed the gas AR into the bubble generating tubes 1 while causing the liquid LQ to flow in between the plurality of bubble generating tubes 1 and the tube surrounding member 271 surrounding around the bubble generating tubes 1 to flow the fine-bubble-containing liquid BLQ outside. In contrast, the generating apparatus 300 in the third embodiment is configured based on an inverted relation between gas AR and liquid LQ such that the plurality of bubble generating tubes 1 are surrounded by a tube surrounding member 371 to feed the gas AR in between the bubble generating tubes 1 and the tube surrounding member 371 while flowing the liquid LQ from one end of each bubble generating tube 1 into the bubble generating tubes and discharging the fine-bubble-containing liquid BLQ from the other end of each bubble generating tube 1.

The generating apparatus 300 includes the plurality of bubble generating tubes 1 (thirteen bubble generating tubes in the first embodiment), a one-side support member 310 supporting each of the one end portions 2 (left end portions in FIG. 7) of the bubble generating tubes 1, an other-side support member 340 supporting each of the other end portions 3 (right end portions in FIG. 7) of the bubble generating tubes 1, and an interval keeping member 370 for keeping the interval, or distance, between the one-side support member 310 and the other-side support member 340. The bubble generating tubes 1 are identical to those in the first and second embodiments and thus their explanation is omitted.

Of each of the bubble generating tubes 1, the one end portion 2 is supported by the one-side support member 310 and the other end portion 3 is supported by the other-side support member 340 (see FIG. 7). The one-side support member 310 includes a one-side holder 311 having a nearly circular disc-like shape, first packings 321, and a one-side cover member 311 covering the one-side holder 311 from the one side NX1 in the longitudinal direction NX.

The one-side holder 311 made of stainless material includes a liquid distribution part 316 formed therethrough with thirteen generating-tube insertion holes 312 in which the one end portions 2 of the bubble generating tubes 1 are individually inserted. The generating-tube insertion holes 312 are placed in predetermined positions around the axis AX as in the first and second embodiments (see FIG. 8). Each of the generating-tube insertion holes 312 is provided with a packing groove 313 annularly extending with a larger diameter than each generating-tube insertion hole 312. In each packing groove 313, one first packing 321 (an O-ring) made of EPDM is mounted. Accordingly, since the one end portions 2 of the bubble generating tubes 1 are inserted in the corresponding generating-tube insertion holes 312, the one end portions 2 of the bubble generating tubes 1 can be gas-tightly and liquid-tightly retained in the one-side holder 311 through the first packing 321 while the liquid LQ is fed from a portion of the one-side holder 311 on the one side NX1 into each of the bubble generating tubes 1.

A peripheral portion of the one-side holder 311 is formed with a stepwise cutout, forming a locking stepped portion 314 in which a first flange 373 formed on one side of an after-mentioned tube surrounding member 371 (the interval keeping member 270) is fitted and locked. Further, as described later, the one-side holder 311 is further formed with six bolt insertion holes 315 in six positions through which shafts 324 of bolts 323 are inserted to fasten the one-side cover member 331, the one-side holder 311, and the first flange 373 of the tube surrounding member 371.

Further, the liquid distribution part 316 is provided with a liquid distribution recess 317 recessed over a range in which the generating-tube insertion holes 312 exist, that is, a range in which the one end portions 2 of the bubble generating tubes 1 are exposed. Through the liquid distribution recess 317 forming a liquid distribution pathway, the liquid LQ having flowed therein through a liquid inflow part 335 mentioned later is distributed into each bubble generating tube 1 (each one end portion 2), as indicated by solid arrows in FIG. 7.

The one-side cover member 331 made of stainless material includes a one-end portion cover part 332 of a circular disc-like shape and the liquid inflow part 335 protruding from the center of the cover part 32 toward the one side NX1 in the longitudinal direction. A liquid inlet 336 formed in the liquid inflow part 335 is connected to a liquid pipe (not shown) or the like to allow the liquid LQ to flow in the liquid inflow part 335. The one-end portion cover part 332 covers the one end portions 2 of the bubble generating tubes 1 so that the liquid distribution recess 317 forms a space between the cover part 332 and the liquid distribution part 316 of the one-side holder 311 to deliver the liquid LQ having flowed therein to each bubble generating tube 1. Furthermore, a peripheral portion of the one-side cover member 331 also includes bolt insertion holes 334 formed in six positions coaxially aligned with the bolt insertion holes 315 of the one-side holder 311 so that the shafts 324 of the bolts 323 are inserted through the bolt insertion holes 334.

On the other hand, the other-side support member 340 includes an other-side holder 341 having a nearly circular disc-like shape, second packings 351, and an other-side cover member 361 covering the other-side holder 341 from the other side NX2 in the longitudinal direction NX.

The other-side holder 341 made of stainless material includes a collecting pathway part 346 formed with thirteen generating-tube insertion holes 342 in which the other end portions 3 of the bubble generating tubes 1 are inserted, the generating-tube insertion holes 342 being placed in predetermined positions around the axis AX (see FIG. 8). Each of the generating-tube insertion holes 342 is provided with a packing groove 343 annularly extending with a larger diameter than each generating-tube insertion hole 342. In each packing groove 343, one second packing 351 (an O-ring) made of EPDM is mounted. Accordingly, since the other end portions 3 of the bubble generating tubes 1 are inserted in the generating-tube insertion holes 342, the other end portions 3 of the bubble generating tubes 1 can be gas-tightly and liquid-tightly retained in the other-side holder 341 through the second packings 351.

A peripheral portion of the other-side holder 341 is formed with a stepwise cutout, forming a locking stepped portion 344 in which a second flange 374 formed on the other side of the after-mentioned tube surrounding member 371 is fitted and locked. Further, as described later, the other-side holder 341 is further formed with bolt insertion holes 345 in six positions through which shafts 354 of bolts 353 are inserted to fasten the other-side cover member 361, the other-side holder 341, and the second flange 374 of the tube surrounding member 371.

Further, the collecting pathway part 346 is provided with a collecting pathway recess 347 recessed over a range in which the generating-tube insertion holes 342 exist, that is, a range in which the other end portions 3 of the bubble generating tubes 1 are exposed. Through the collecting pathway recess 347 forming a liquid collecting pathway, the fine-bubble-containing liquid BLQ having flowed therein from the other end portions 3 of the bubble generating tubes 1 are collected as indicated by solid striped arrows in FIG. 7 and further directed to a liquid outflow part 365 mentioned later.

The other-side cover member 361 made of stainless material includes an other-end portion cover part 362 of a circular disc-like shape and a liquid outflow part 365 protruding from the center of the cover part 362 toward the other side NX2 in the longitudinal direction. A liquid outlet 366 formed in the liquid outflow part 365 is connected to a liquid pipe (not shown) or the like to allow the fine-bubble-containing liquid BLQ to flow out from the liquid outflow part 365. The other-end portion cover part 362 covers the other end portions 3 of the bubble generating tubes 1 so that the collecting pathway recess 347 forms a space between the cover part 362 and the collecting pathway part 346 of the other-side holder 341 to direct the fine-bubble-containing liquid BLQ having flowed out of the bubble generating tubes 1 through their other end portions 3 to the liquid outflow part 365. Furthermore, a peripheral portion of the other-side cover member 361 also includes bolt insertion holes 364 formed in six positions coaxially aligned with the bolt insertion holes 345 of the other-side holder 341 so that the shafts 354 of the bolts 353 are inserted through the bolt insertion holes 364.

In the third embodiment, the interval keeping member 370 for keeping the interval between the one-side support member 310 and the other-side support member 340 includes the tube surrounding member 371, the bolts 323, and the bolts 353. The tubular tube surrounding member 371 made of stainless steel includes a tube surrounding part 372 having a tubular shape and surrounding around the thirteen bubble generating tubes 1 and further the first flange 373 extending radially outward from an end of the tube surrounding part 372 on the one side NX1 in the longitudinal direction, and the second flange 374 extending radially outward from an end of the tube surrounding part 372 on the other side NX2 in the longitudinal direction. The tube surrounding part 372 is provided, in its middle part in the longitudinal direction NX, with a gas inflow part 376 protruding outward and forming a gas inlet 377.

The first flange 373 of the tube surrounding member 371 is fitted on the locking stepped portion 314 of the one-side holder 311 and further external thread parts 325 of the bolts 323 inserted through the bolt insertion holes 334 of the one-side cover member 331 and the bolt insertion holes 315 of the one-side holder 311 are screwed in corresponding internal thread holes 373A of the first flange 373 to fasten together the one-side cover member 331, the one-side holder 311, and the tube surrounding member 371 (the first flange 373). Further, the second flange 374 of the tube surrounding member 371 is fitted on the locking stepped portion 344 of the other-side holder 341 and further external thread parts 355 of the bolts 353 inserted through the bolt insertion holes 364 of the other-side cover member 361 and the bolt insertion holes 345 of the other-side holder 341 are screwed in internal thread holes 374A of the second flange 374 to fasten together the other-side cover member 361, the other-side holder 341, and the tube surrounding member 371 (the second flange 374). With this tube surrounding member 371, the interval M between the one-side support member 310 and the other-side support member 340 is limited to a predetermined dimension.

The following explanation will be given to the arrangement of thirteen bubble generating tubes 1 in the generating apparatus 300 in the third embodiment with reference to FIG. 8 and FIG. 3. This FIG. 8 shows only each end face of the thirteen bubble generating tubes 1 and the tube surrounding member 371 (the tube surrounding part 372) in a cross section of the generating apparatus 300 taken along a line C-C in FIG. 7. The arrangement of the thirteen bubble generating tubes 1 is identical to that in the first and second embodiment and thus its explanation is omitted. The thirteen bubble generating tubes 1 are arranged in rotational symmetry at angular intervals of 60 degrees around the axis AX and arranged in a pattern that the bubble generating tubes 1 are individually centered at apexes of imaginary equilateral triangles congruent with each other (see FIG. 3). Since the plurality of bubble generating tubes 1 are arranged in the above configuration, the bubble generating tubes 1 can be placed in a balanced manner around the central bubble generating tube 10. Thus, the generating apparatus 300 can be configured such that the plurality of bubble generating tubes 1 are reliably supported by the one-side support member 310 (the one-side holder 311) and the other-side support member 340 (the other-side holder 341).

The generating apparatus 300 in the third embodiment is configured, as shown in FIG. 7, to feed the gas AR to the outside of the bubble generating tubes 1 placed in the tube surrounding part 372 through the gas inflow part 376 of the tube surrounding part 372. On the other hand, the generating apparatus 300 is configured to distribute the liquid LQ having flowed therein through the liquid inflow part 335 to the one end portions 2 of the bubble generating tubes 1 to allow the liquid LQ to flow through the inside of each bubble generating tube 1 through each one end portion 2. Further, the generating apparatus 300 is also configured to collect the fine-bubble-containing liquid BLQ having flowed out from the other end portions 3 of the bubble generating tubes 1 and flow the fine-bubble-containing liquid BLQ outside through the liquid outflow part 365. The liquid LQ having flowed in each bubble generating tube 1 then flows through the middle portion 4 of each bubble generating tube 1 in the longitudinal direction NX (toward the other side NX2 (rightward in the figure) in the third embodiment). While the liquid LQ is flowing through the middle portion 4 of each bubble generating tube 1, fine bubbles BB is generated from the inner peripheral surface of the middle portion 4 of each bubble generating tube 1 and injected into the liquid LQ.

In the generating apparatus 300, the plurality of bubble generating tubes 1 (thirteen bubble generating tubes in the first embodiment) are used to distribute a liquid LQ into each of the bubble generating tubes 1. This enables generation of fine bubbles BB from each of the middle portions 4 of the bubble generating tubes 1. Specifically, the generating apparatus 300 can provide increased surface areas of the middle portions 4 (porous ceramics) of the bubble generating tubes 1 to contact the liquid LQ and thus inject more fine bubbles BB into the liquid LQ.

In addition, the the bubble generating tubes can be designed to be shorter in length as compared with a configuration using a single long bubble generating tube. Thus, the generating apparatus 300 for generating a fine-bubble-containing liquid BLQ can be achieved with high reliability and provided with the bubble generating tubes 1 each having high strength.

Furthermore, in the generating apparatus 300 in the third embodiment, when fine bubbles BB of gas AR are injected into the liquid LQ, the liquid LQ is not exposed to outside air. Therefore, the liquid LQ in a clean state can be made into a fine-bubble-containing liquid BLQ.

The present invention is described in the aforementioned first through third embodiments but is not limited to those embodiments. The present invention may be appropriately embodied in other specific forms without departing from the essential characteristics thereof. The number of bubble generating tubes used in each of the embodiment is thirteen, but also may be a different number. In particular, other numbers, e.g., seven, nineteen, thirty-one, or another number may be set in such a way that peripheral bubble generating tubes 11 arranged in rotational symmetry around the central bubble generating tube 10 located at the center and arranged in a pattern that the bubble generating tubes 1 are individually centered at apexes of imaginary equilateral triangles congruent with each other.

Furthermore, the bubble generating tubes 1 made of porous alumina are exemplified but may be made of another kind of porous ceramics (titania, zirconia, silica, silicon nitride, silicon carbide, and others).

Each embodiment exemplifies the configurations that the one-side support member 110 and others and the other-side support member 140 and others are made of metal material such as stainless steel. As an alternative, a portion (a member) that comes into contact with the liquid LQ may be made of resin such as fluorine resin or non-metal material such as alumina and ceramics. As another alternative, a portion or member made of metal material, which will contact with a liquid may be applied with lining such as fluorine resin.

### REFERENCE SIGNS LIST

100, 200, 300 Device for generating fine-bubble-containing liquid
NX Longitudinal direction (of Bubble generating tube)
NX1 One side (in Longitudinal direction)
NX2 Other side (in Longitudinal direction)
1 Bubble generating tube
10 Central bubble generating tube
AX Axial line (of Central bubble generating tube)
11 Peripheral bubble generating tube
2 One end portion (of Bubble generating tube)
3 Other end portion (of Bubble generating tube)
4 Middle portion (of Bubble generating tube)
110, 210, 310 One-side support member
140, 240, 340 Other-side support member
170, 270, 370 Interval keeping member
M Interval (between One-side support member and Other-side support member)
111, 211, 311 One-side holder (One-side support member)
112, 212, 312 Generating-tube insertion hole (of One-side holder)
113, 213, 313 Packing groove (of One-side holder)
114 Column stop hole (of One-side holder)
216 Gas distribution part
217 Gas distribution recess (Gas distribution pathway)
316 Liquid distribution part
317 Liquid distribution recess
121, 221, 321 First packing (One-side support member)
223, 323 Bolt (One-side support member, Interval keeping member)
131, 231, 331 Cover member (One-side support member)
132 Gas distribution part
133 Gas distribution recess
135, 235 Gas inflow part
136, 236 Gas inlet
335 Liquid inflow part
336 Liquid inlet
141, 241, 341 Other-side holder (Other-side support member)
142, 242, 342 Generating-tube insertion hole (of Other-side holder)
143, 243, 343 Packing groove (of Other-side holder)
346 Collecting pathway part
347 Collecting pathway recess (Liquid collecting pathway)
151, 251 Second packing (Other-side support member)
253, 353 Bolt (Other-side support member, Interval keeping member)
161, 261, 361 Other-side cover member (Other-side support member)
264, 364 Bolt insertion hole
365 Liquid outflow part
366 Liquid outlet
171 Column member (Interval keeping member)
271, 371 Tube surrounding member (Interval keeping member)
272, 372 Tube surrounding part (of Tube surrounding member)
276 Liquid inflow part
277 Liquid inlet
278 Liquid outflow part
279 Liquid outlet
376 Gas inflow part
377 Gas inlet
191 Nut (Interval keeping member)
193 Washer (Interval keeping member)
AR Gas
LQ Liquid
BB Bubble
BLQ Microbubble-containing liquid

1. An apparatus for generating a fine-bubble-containing liquid, comprising:
a plurality of bubble generating tubes, each having a tubular shape extending in a longitudinal direction, in which at least a middle portion between a one end portion and an other end portion of each tube is made of porous ceramics, and each bubble generating tube being configured to inject bubbles into a liquid that contacts the middle portion;
a one-side support member supporting each of the one end portions of the plurality of bubble generating tubes;
an other-side support member supporting each of the other end portions of the plurality of bubble generating tubes; and
an interval keeping member keeping an interval between the one-side support member and the other-side support member.

2. The apparatus for generating a fine-bubble-containing liquid according to claim 1, wherein
the plurality of bubble generating tubes include a central bubble generating tube located at a center and peripheral bubble generating tubes arranged around the central bubble generating tube,
in a cross section perpendicular to the longitudinal direction, the peripheral bubble generating tubes placed around the central bubble generating tube are arranged in rotational symmetry with respect to the central bubble generating tube, and
the bubble generating tubes are arranged in a pattern that the bubble generating tubes are individually centered at apexes of imaginary equilateral triangles congruent with each other.

3. The apparatus for generating a fine-bubble-containing liquid according to claim 1, wherein
the one-side support member includes:
a liquid inflow part forming a liquid inlet in which the liquid flows; and
a liquid distribution part forming a liquid distribution pathway to distribute the liquid having flowed in the one-side support member to the one end portions of the plurality of bubble generating tubes,
the other-side support member includes:
a liquid outflow part forming a liquid outlet from which the fine-bubble-containing liquid flows out; and
a collecting pathway part forming a liquid collecting pathway to direct the fine-bubble-containing liquid having flowed out through the other end portions of the plurality of bubble generating tubes toward the liquid outlet, and
the interval keeping member includes:
a tube surrounding part having a tubular shape and gas-tightly surrounding around the plurality of bubble generating tubes between the one-side support member and the other-side support member; and
a gas inflow part forming a gas inlet to direct pressurized gas into the tube surrounding part.

4. The apparatus for generating a fine-bubble-containing liquid according to claim 1, wherein
the one-side support member includes:
a gas inflow part forming a gas inlet in which pressurized gas flows; and
a gas distribution part forming a gas distribution pathway to distribute the gas having flowed in the one-side support member to the one end portions of the plurality of bubble generating tubes,
the interval keeping member includes:
a tube surrounding part having a tubular shape and gas-tightly surrounding around the plurality of bubble generating tubes between the one-side support member and the other-side support member, and
the generating apparatus is provided with a liquid inflow part and a liquid outflow part in a configuration to allow the liquid to flow in between the plurality of bubble generating tubes and the tube surrounding part, allow the liquid having flowed therein to flow in the longitudinal direction along the middle portions of the bubble generating tubes, and allow the fine-bubble-containing liquid to flow out of the tube surrounding part.

5. The apparatus for generating a fine bubble-containing liquid according to claim 2, wherein
the one-side support member includes:
a liquid inflow part forming a liquid inlet in which the liquid flows; and
a liquid distribution part forming a liquid distribution pathway to distribute the liquid having flowed in the one-side support member to the one end portions of the plurality of bubble generating tubes,
the other-side support member includes:
a liquid outflow part forming a liquid outlet from which the fine bubble-containing liquid flows out; and
a collecting pathway part forming a liquid collecting pathway to direct the fine bubble-containing liquid having flowed out through the other end portions of the plurality of bubble generating tubes toward the liquid outlet, and
the interval keeping member includes:
a tube surrounding part having a tubular shape and gas-tightly surrounding around the plurality of bubble generating tubes between the one-side support member and the other-side support member; and
a gas inflow part forming a gas inlet to direct pressurized gas into the tube surrounding part.

6. The apparatus for generating a fine bubble-containing liquid according to claim 2, wherein
the one-side support member includes:
a gas inflow part forming a gas inlet in which pressurized gas flows; and
a gas distribution part forming a gas distribution pathway to distribute the gas having flowed in the one-side support member to the one end portions of the plurality of bubble generating tubes,
the interval keeping member includes:
a tube surrounding part having a tubular shape and gas-tightly surrounding around the plurality of bubble generating tubes between the one-side support member and the other-side support member, and
the generating apparatus is provided with a liquid inflow part and a liquid outflow part in a configuration to allow the liquid to flow in between the plurality of bubble generating tubes and the tube surrounding part, allow the liquid having flowed therein to flow in the longitudinal direction along the middle portions of the bubble generating tubes, and allow the fine bubble-containing liquid to flow out of the tube surrounding part.
